(19) United States
(12) Patent Application Publication
(10) Pub. No.: US 2019/0073689 A1
(43) Pub. Date: Mar. 7, 2019

(54) NORMALIZED INCENTIVIZATION SYSTEMS AND METHODS TO FACILITATE DECENTRALIZED TASK MANAGEMENT

(71) Applicant: STORMX GLOBAL SEZC, INC., Seattle, WA (US)

(72) Inventors: Byung Hoon YU, Seattle, WA (US); Calvin HSIEH, Seattle, WA (US); Esther SONG, Auburn, WA (US); Edward CHEUNG, Seattle, WA (US); Arry S. YU, Seattle, WA (US)

(21) Appl. No.: 15/874,356

(22) Filed: Jan. 18, 2018

Related U.S. Application Data
(60) Provisional application No. 62/554,536, filed on Sep. 5, 2017.

(51) Int. Cl. G06Q 30/02; G06Q 50/00

(52) U.S. Cl. CPC G06Q 30/0239; G06Q 50/01; G06Q 20/065; G06Q 30/0277; G06Q 30/0267; G06Q 30/0255

(57) ABSTRACT

Methods and systems are presented for facilitating decentralized task management by implementing incentivization through tasksets that are staged in sequence (so that an earlier taskset unlocks a latter one, e.g.) and by one or more eligibility notifications that depend upon a party's preferences.

### RELATED APPLICATIONS

This application claims the benefit of provisional U.S. App. No. 62/554,536 (“Normalized incentivization systems and methods to facilitate decentralized task management”) filed 5 Sep. 2017, which is incorporated herein by reference in its entirety.

### BRIEF DESCRIPTION OF THE DRAWINGS

FIG. 1 depicts a system in which respective entities each employ one or more servers or client devices according to one or more embodiments.

FIG. 2 depicts a network and device diagram illustrating exemplary client devices configured according to one or more embodiments.

FIG. 3 depicts a server according to one or more embodiments.

FIG. 4 depicts media-resident data objects according to one or more embodiments.

FIG. 5 depicts physical forms or other suitability indicia that demonstrate an ability or inclination of a party to perform a task according to one or more embodiments.

FIG. 6 depicts a list of records each describing a taskset according to one or more embodiments.

FIG. 7 depicts a system in which three client devices are located in a geographic region according to one or more embodiments.

FIG. 8 depicts a particular scenario and progressive data flow in which one or more client devices and servers interact according to one or more embodiments.

FIG. 9 depicts a participant sign up process flow according to one or more embodiments.

FIG. 10 depicts an incentive earning flow according to one or more embodiments.

FIG. 11 depicts another incentive earning flow according to one or more embodiments.

FIG. 12 depicts a dispensation flow according to one or more embodiments.

FIG. 13 depicts an affiliate enlistment flow according to one or more embodiments.

FIG. 14 depicts an offer addition flow according to one or more embodiments.

FIG. 15 depicts special-purpose transistor-based circuitry according to one or more embodiments.

FIG. 16 depicts an incentivization flow according to one or more embodiments.

FIG. 17 depicts another incentivization flow according to one or more embodiments.

### DETAILED DESCRIPTION

The detailed description that follows is represented largely in terms of processes and symbolic representations of operations by conventional computer components, including a processor, memory storage devices for the processor, connected display devices and input devices. Furthermore, some of these processes and operations may utilize conventional computer components in a heterogeneous distributed computing environment, including remote file servers, computer servers and memory storage devices.

It is intended that the terminology used in the description presented below be interpreted in its broadest reasonable manner, even though it is being used in conjunction with a detailed description of certain example embodiments. Although certain terms may be emphasized below, any terminology intended to be interpreted in any restricted manner will be overtly and specifically defined as such.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

“Above,” “aggregated,” “allowed,” “apparent,” “as,” “associated,” “automatic,” “based,” “before,” “being,” “caused,” “changed,” “completed,” “conditional,” “configured,” “described,” “determined,” “disclosed,” “eligible,” “first,” “for,” “from,” “human,” “identified,” “included,” “likewise,” “local,” “manifesting,” “many,” “matching,” “mixed,” “more,” “offline,” “older,” “online,” “particular,” “recent,” “requested,” “respective,” “responsive,” “scalar,” “second,” “sequential,” “several,” “to,” “transmitting,” “true,” “unique,” “unlocked,” “updated,” “via,” “with,” or other such descriptors herein are used in their normal yes-or-no sense, not merely as terms of degree, unless context dictates otherwise. In light of the present disclosure those skilled in the art will understand from context what is meant by “remote” and by other such positional descriptors used herein. Terms like “processor,” “center,” “unit,” “computer,” or other such descriptors herein are used in their normal sense, in reference to an inanimate structure. Such terms do not include any people, irrespective of their location or employment or other association with the thing described, unless context dictates otherwise. “For” is not used to articulate a mere intended purpose in phrases like “circuitry for” or “instruction for,” moreover, but is used normally, in descriptively identifying special purpose software or structures.

As used herein and consistent with common parlance, an “online” taskset refers to one or more tasks primarily performed by a party while online (i.e. via a computing device in communication with or through a network of devices). Such tasksets include creating online accounts remotely, receiving streaming content (ads or training materials, e.g.), transmitting content (digitally encoded remarks, e.g.) via electrical or optical communications linkages, or other such tasks performed via a network linkage. Likewise an “offline” taskset refers herein to one or more tasks primarily performed by a party while offline (i.e. not via a computing device in communication with a network of devices). Such tasksets include traveling in person, talking face-to-face, handling or manipulating real-world objects, taking medication, or other such tasks performed in person. A taskset may be “offline” even if it includes an online reporting component, however. And if the offline and online portions of a given taskset are similar in magnitude (each being 40% to 60% of the whole, e.g.) then that taskset is neither an “online” nor an “offline” taskset, but is rather a “hybrid” as described herein.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

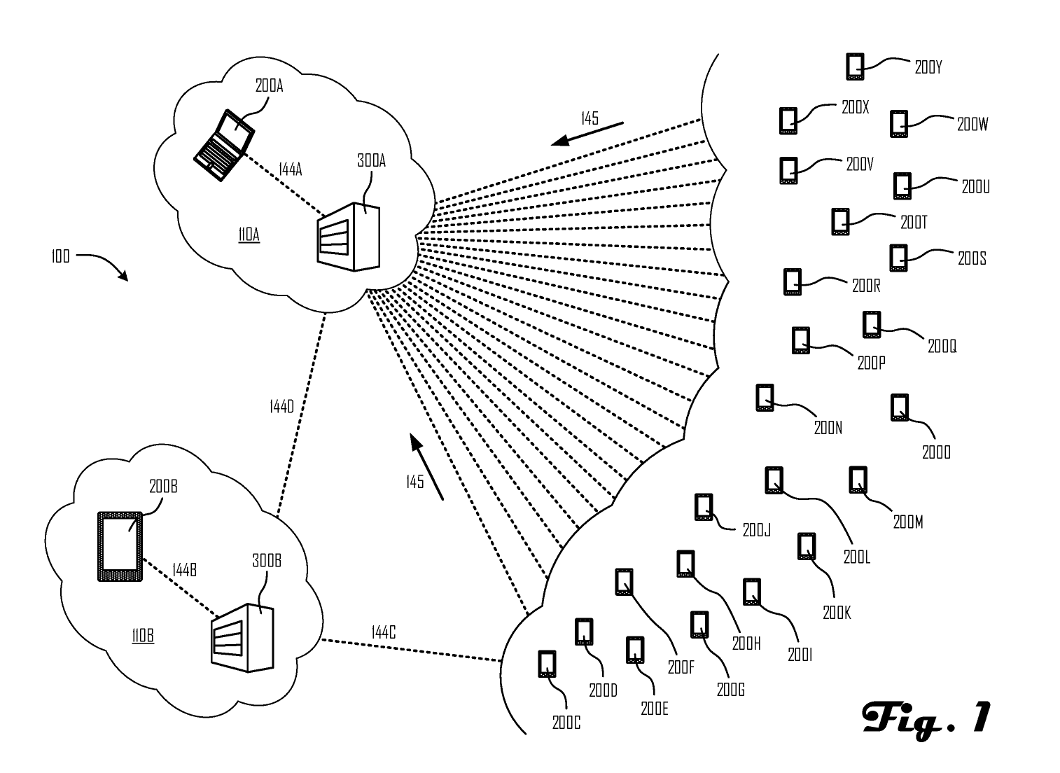

FIG. 1 schematically illustrates a system 100 in which respective entities 110A-B interact with one another and with participating crowdsource or similar distributed devices 200C-Y many of which are, at various times, able to confirm an asset transfer or other occurrence as described below (by confirmations 145, e.g.). A sponsoring entity 110A comprises one or more affiliate servers 300A that interact with one or more client devices 200A thereof (via respective instances of linkage 144A, e.g.). A service entity 110B comprises one or more task management servers 300B that interact with one or more client devices 200B thereof (via respective instances of linkage 144B, e.g.). A party comprises one or more client devices 200C-Y and their users. In some instances (in response to interactions via linkages 144C-D, e.g.) the entities 110A-B may cooperate so that updates (indicia of offers, dispensations, or other events, e.g.) to values maintained at server 300B are received and so that adequately timely confirmations to those updates can occur in a decentralized fashion.

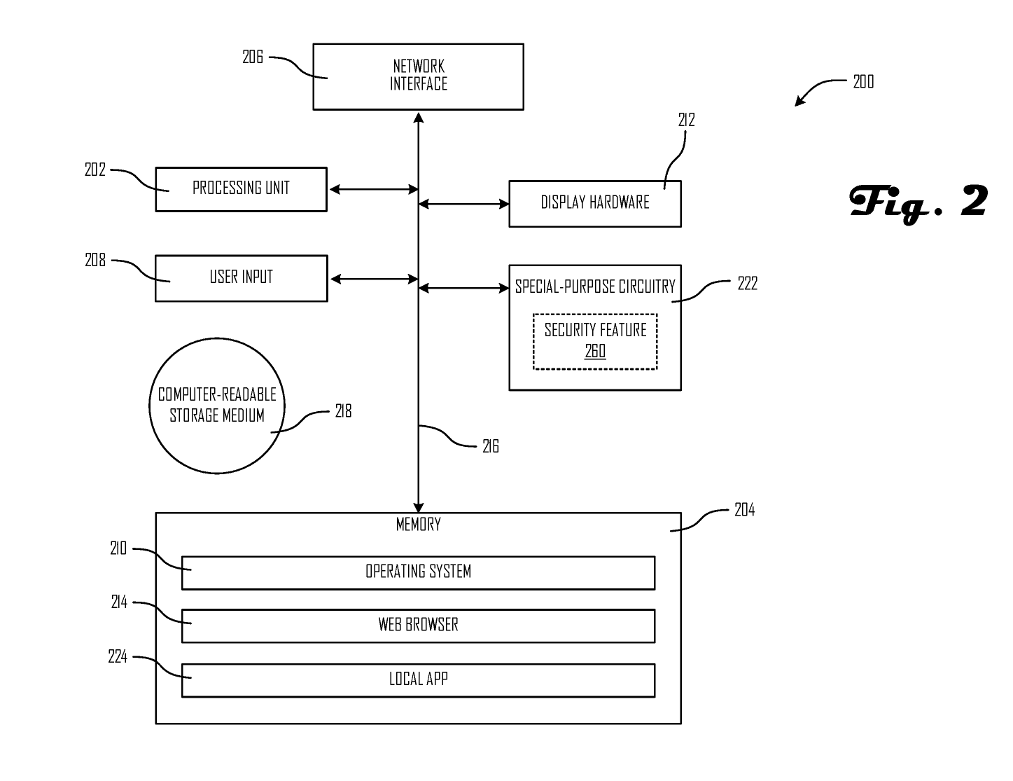

FIG. 2 illustrates several components of an exemplary client device 200 (like those of devices 200A-Y, e.g.). As used herein, a plain reference numeral (like 200, e.g.) may refer generally to a member of a class of items (like client devices, e.g.) exemplified with a hybrid numeral (like 200Q, e.g.) and it will be understood that every item identified with a hybrid numeral is also an exemplar of the class. In some embodiments, client device 200 may include many more components than those shown in FIG. 2. However, it is not necessary that all conventional components be shown in order to disclose an illustrative embodiment. As shown in FIG. 2, client device 200 includes a data network interface 206 (for connecting via the Internet or other networks to or within entities 110 of FIG. 1, e.g.).

Client device 200 may also include one or more instances of processing units 202, memory 204, user inputs 208, and display hardware 212 all interconnected along with the network interface 206 via a bus 216. Memory 204 generally comprises a random access memory (“RAM”), a read only memory (“ROM”), and a permanent mass storage device, such as a disk drive.

Memory 204 may likewise contain one or more instances of operating systems 210, web browsers 214, and local apps 224. These and other software components may be loaded from a non-transitory computer readable storage medium 218 into memory 204 of the client device 200 using a drive mechanism (not shown) associated with a non-transitory computer readable storage medium 218, such as a floppy disc, tape, DVD/CD-ROM drive, flash card, memory card, or the like. In some embodiments, software components may also be loaded via the network interface 206, rather than via a computer readable storage medium 218. Special-purpose circuitry 222 may, in some variants, include some or all of the event-sequencing logic described below (in a peer-to-peer implementation, e.g.) and one or more security features 260 (a fob or similar security apparatus, e.g.).

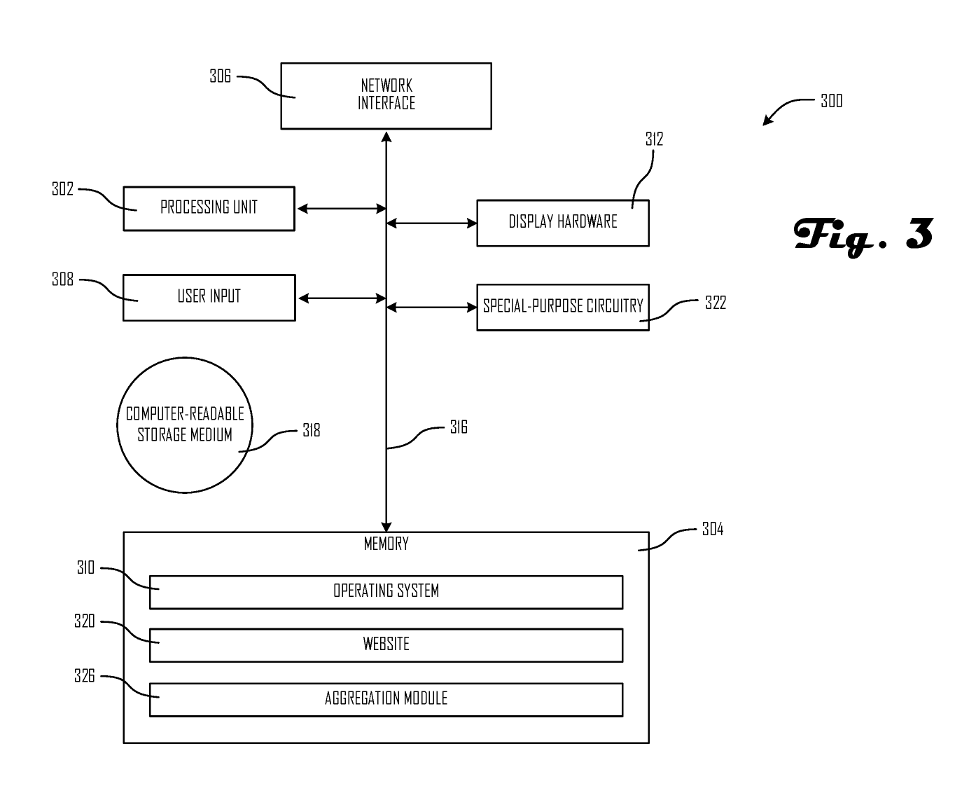

FIG. 3 illustrates several components of an exemplary server (like those of server 300, e.g.). As shown in FIG. 3, server 300 includes a data network interface 306 for connecting via the Internet or other networks (or both) to client devices 200A-Y of FIG. 1.

Server 300 may also include one or more instances of processing units 302, memory 304, user inputs 308, and display hardware 312 all interconnected along with the network interface 306 via a bus 316. Memory 304 generally comprises a random access memory (“RAM”), a read only memory (“ROM”), and a permanent mass storage device, such as a disk drive.

Memory 304 may likewise contain an operating system 310, hosted website 320, and aggregation module 326. These and other software components may be loaded from a non-transitory computer readable storage medium 318 into memory 304 of the server 300 using a drive mechanism (not shown) associated with a non-transitory computer readable storage medium 318, such as a floppy disc, tape, DVD/CD-ROM drive, flash card, memory card, or the like. In some embodiments, software components may also be loaded via the network interface 306, rather than via a computer readable storage medium 318. Special-purpose circuitry 322 may, in some variants, include some or all of the event-sequencing logic described below.

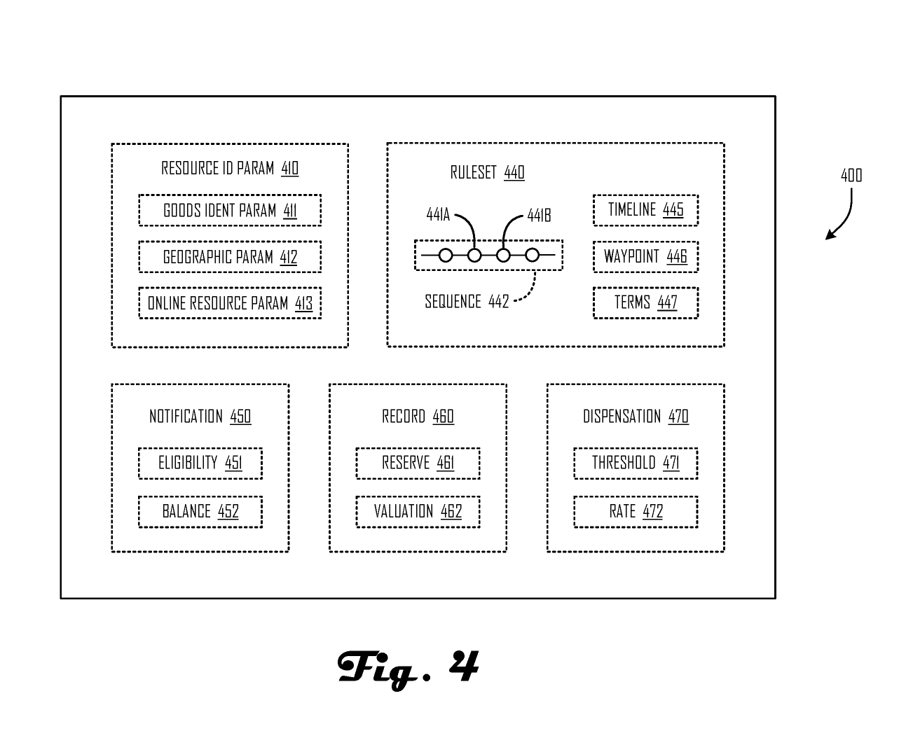

FIG. 4 depicts one or more nonvolatile data storage media 400 configured to handle various data objects. These may include one or more instances of resource identification parameters 410 by which a party who performs one or more tasksets or an affiliate (campaign sponsor, e.g.) may specify one or more acceptable resources (as an individual item or category of items, e.g.) suitable for use as an incentive. In some instances such resources may be granular (generally requiring many days of labor or an equivalent expenditure to earn, e.g.). Such parameters may (optionally) include one or more instances of goods identification parameters 411, of geographic parameters 412, or of online resource parameters 413. Online resources may include a computing resource (processing capacity or access privileges, e.g.) or a cryptocurrency (in denominations of “Bitcoins” or “Tokens” in the implementations described in the appendices below, e.g.), for example. Medium 400 may also include one or more ruleset sequences 442 or other tasksets 441A-B specified with relation to one or more instances of timelines 445, of waypoints 446, or of other task completion terms 447 (all specified by a sponsoring entity 110A when defining a campaign, e.g.). Medium 400 may also include one or more instances of eligibilities 451, of balances 452, or of other (aspects or components of) notifications 450. Medium 400 may also include one or more instances of reserves 461, of valuations 462, or of other (aspects or components of) records 460. Medium 400 may also include one or more instances of thresholds 471, of transfer/conversion rates 472, or of other (aspects or components of) dispensations 470.

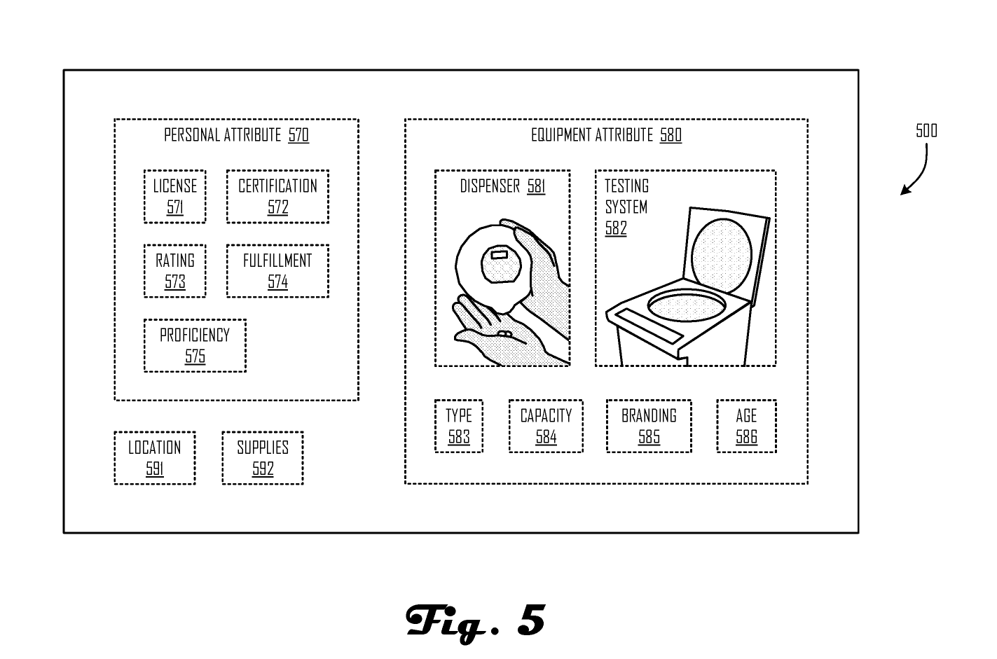

FIG. 5 depicts physical forms or other suitability indicia 500 that demonstrate an ability or inclination of a party to perform a task well and reliably. Such indicia may include one or more instances of licenses 571 or certification 572 (granted by a government within a jurisdiction for a limited period, e.g.); of ratings 573 (by peers, e.g.); of fulfillments 574 (of successful in-app transactions, e.g.); of other proficiencies (in multiple languages, e.g.); or of other such personal attributes 570 (awards or other accolades, e.g.) signifying suitability for facilitating a taskset completion. Such indicia may likewise include one or more instances of dispensers 581 (or other devices configured to monitor apparent health regimen compliance, e.g.); of testing systems 582 (or other specialty equipment able to perform scientific tasksets; of types 583 (of other specialty equipment, e.g.); of capacities 583 (indicative of surplus capacity at a facility at which tasksets are performed, e.g.); of branding 585 (trademarks or other idicia of corporate affiliation, e.g.); of equipment age 586; or of other such equipment attributes 580. Other such indicia may (optionally) designate one or more locations 591 (identified by a ZIP code, GPS coordinates, or service areas, e.g.) or supplies 592 available for performing the tasksets.

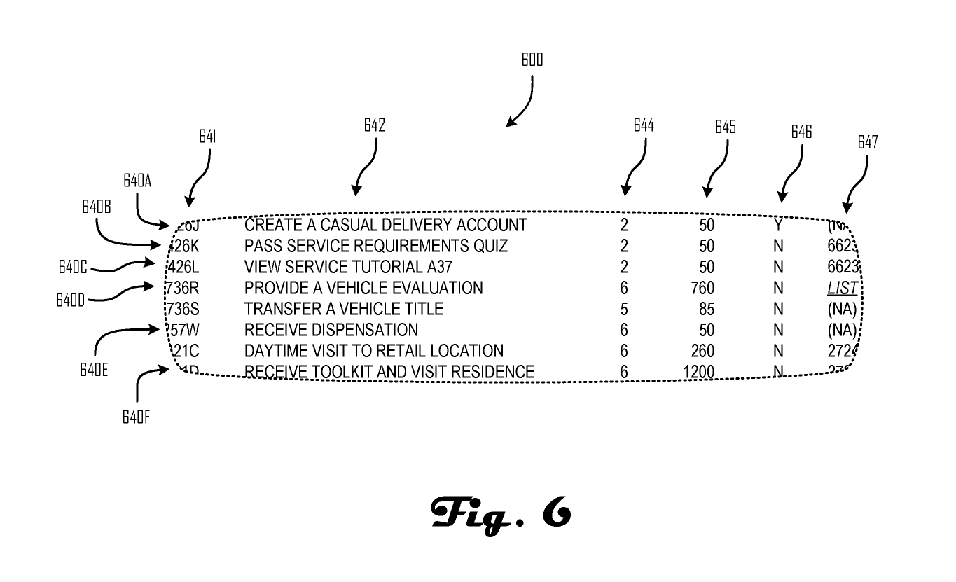

FIG. 6 depicts a list 600 of records 640A-F each describing a taskset 441. Each record may include one or more instances of an alphanumeric taskset identifier 641, a taskset description 642, a taskset type 644, a task completion incentive 645 expressed as units of in-app currency (“Bolts” in the implementation described in the appendices below, e.g.), and a completion status 646. In the records 640 depicted, for example, a taskset type 644 of “2” signifies an online taskset and a taskset type 644 of “6” signifies an offline taskset. Each record may also include one or more prerequisite taskset identifiers 647 that each identify a taskset 441 the completion of which unlocks the described taskset. Record 640D signals a “LIST” of prerequisite tasksets (implemented as a hyperlink to the prerequisite taskset list, e.g.) for use when a taskset sequence 442 requires or allows more than one mode of unlocking the subject taskset. The list 600 for record 640D, for example, may include record 640B or record 640C (or both), according to the preferences of the sponsoring entity.

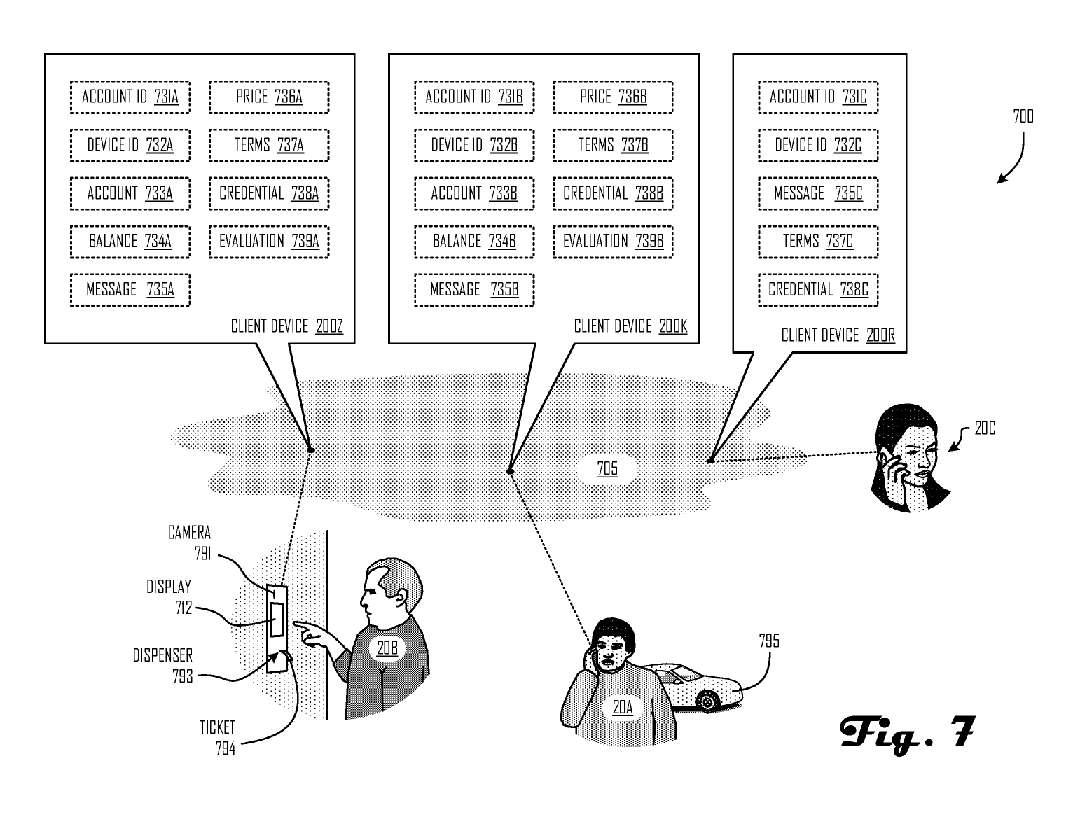

Various distributions of related data objects are likewise contemplated. FIG. 7 depicts a system 700 in which three client devices 200K, 200R, 200Z are located in a geographic region 705 (a city or ZIP code, e.g.). Client device 200K is a mobile device in use by a party 20A seeking to sell his vehicle 795. Client device 200Z is a kiosk in use by a party 20B seeking freelance work as a mechanic. As shown, client device 200Z has a display 712 (i.e. an instance of display hardware 212), a camera 791, and a dispenser 793 configured to print out tickets 794 as further described below.

In one scenario a first party 20B may be notified of an opportunity (previously defined sponsored by party 20A, e.g.) to earn a first incentive 645 (of 50 units of in-app currency, e.g.) by completing a first taskset (having a taskset description 642 of “VIEW SERVICE TUTORIAL A37” as shown in record 640C, e.g.). This can occur, for example, in a context in which party 20A wants a “PROVIDE A VEHICLE EVALUATION” performed by which potential buyers can be assured that the vehicle 795 has no discoverable latent flaws; in which such assurance will not result unless the service provider has and demonstrates appropriate credentials 738A (appropriate state licensure and an online rating, e.g.); in which the first incentive 645 is large enough to attract potential service providers 20B to overcome these barriers to entry (acquiring skills and building an online presence, e.g.); and in which potential service providers 20B would not otherwise bother to participate on a broad enough scale to justify such infrastructure (systems and methods as described below, e.g.). To assist in establishing such infrastructure, various client devices 200 may (optionally) be associated with one or more instances of account identifiers 731A-C (identifying a party 20 using the device, e.g.); device identifiers 731A-C; accounts 733A-B (implementing a digital wallet or similar mechanism to implement resource ownership, e.g.); balances 734 (of in-app currency, e.g.); messages 735A-C (providing notification as described herein, e.g.); prices 736A-B (as an incentive or other valuation described herein, e.g.); terms 737A-C (defining timing or location of performance, e.g.); credentials 738A-C (demonstrating trustworthiness, e.g.); or evaluations 739A-B.

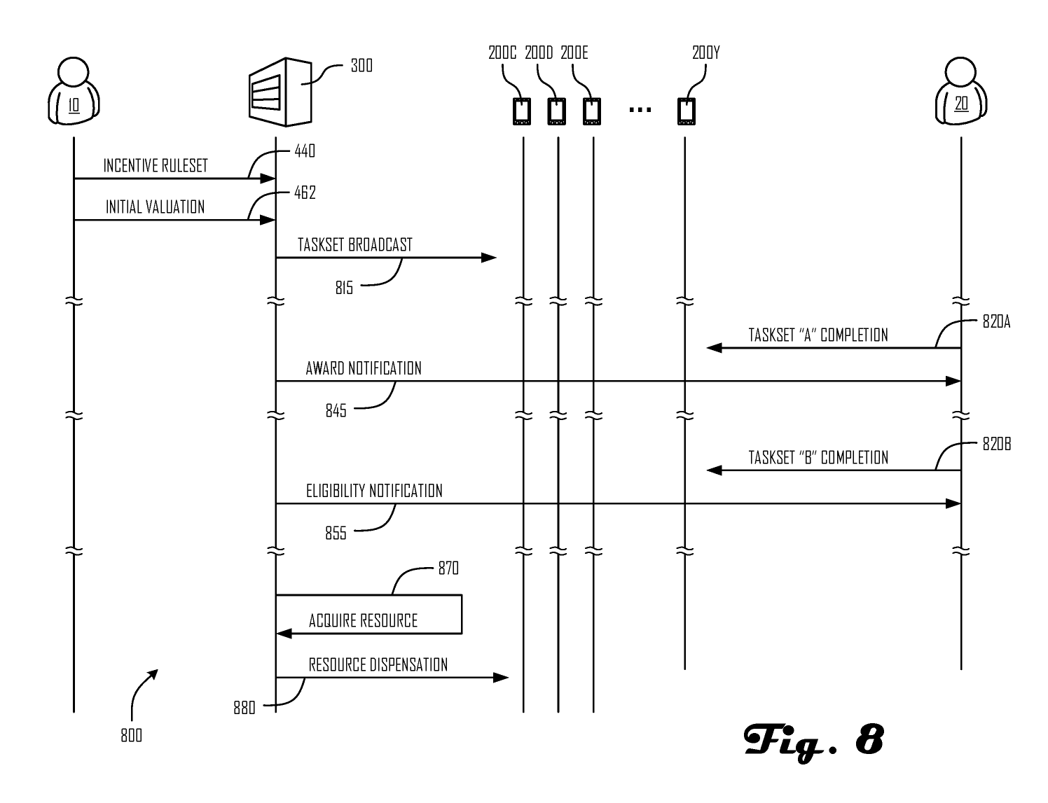

FIG. 8 depicts a particular scenario and progressive data flow 800 in which one or more client devices 200 and servers 300 (operably coupled via linkages 144 or via the Internet as shown in FIG. 1, e.g.) interact. After receiving campaign inception parameters (including an incentive ruleset 440 and initial valuation 462, e.g.) from a sponsoring client device 200A operated by affiliate 10, the one or more servers 300 initiate a taskset broadcast 815 to numerous party/member devices 200. A few hours later, one of the devices 200 (operated by party 20) signals a taskset completion 820A (having reached a waypoint pertaining to one or more tasksets including taskset 441A, e.g.) signaling a reward. Server 300 responds (either to the completion 820A directly or to a crowdsourced verification of such completion from some other devices 200D-200Y, e.g.) by transmitting an award notification 845 (of a small increment of in-app currency, e.g.).

A few more hours later, the device 200 signals a further taskset completion 820B (having reached a subsequent waypoint unlocked by having completed taskset 441A, e.g.). Upon detecting that a completion of the subsequent taskset 441B qualifies the user of device 200B for an eligibility 451 (by virtue of a balance 452 of in-app currency crossing a threshold 471, e.g.), server 300 responds by transmitting an eligibility notification 855. In a context in which server 300 has received a dispensation authorization (implicit or explicit), server 300 then acquires or otherwise allocates the resource 870 and implements a resource dispensation 880 (either to the deserving user of device 200B directly or through a cryptocurrency or other crowdsourced-verification-type transfer, e.g.).

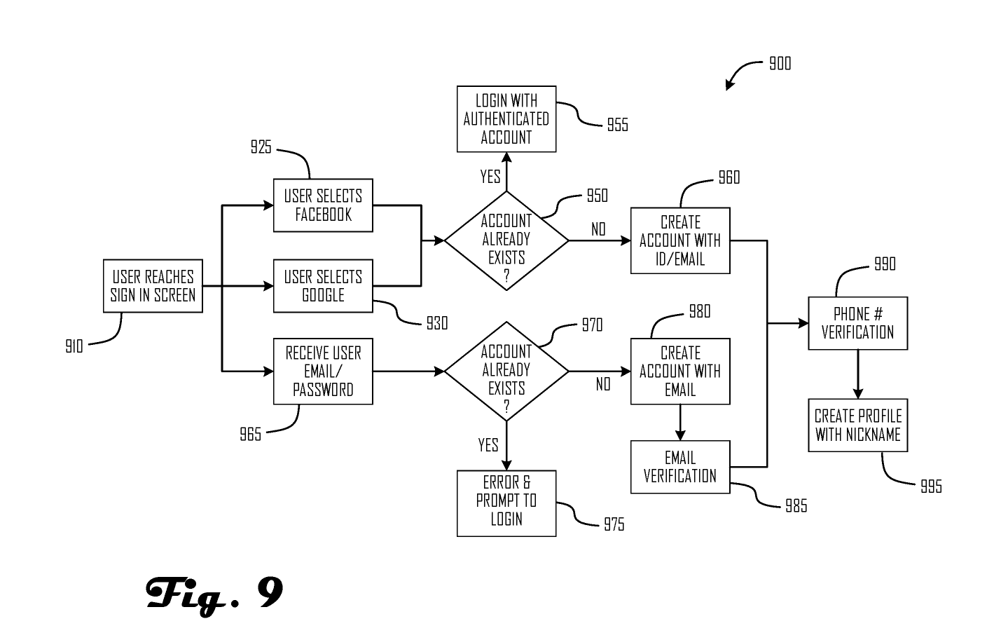

FIG. 9 depicts a participant sign up process flow 900 performed primarily by one or more processing units 202, 302 in response to actions of client device users. At operation 910 a client device user (party 20, e.g.) reaches an (app or browser) sign in screen. If a user selects Facebook® 925 or if a user selects Google®, flow proceeds to operation 950. Otherwise at operation 965 the user's email/password are received and flow proceeds to operation 970.

At operation 950 if a social media account already exists then at operation 955 a login is performed with the account. Otherwise an account is created with the user's account identifier or email address and flow proceeds to operation 990.

At operation 970 if an email account already exists then at operation 975 a login is performed with the account. Otherwise an account is created with the user's email address and (after email verification at operation 985 flow proceeds to operation 990.

At operation 990 a phone number verification is performed 990 and at operation 995 a profile is created, allowing the user to select a nickname.

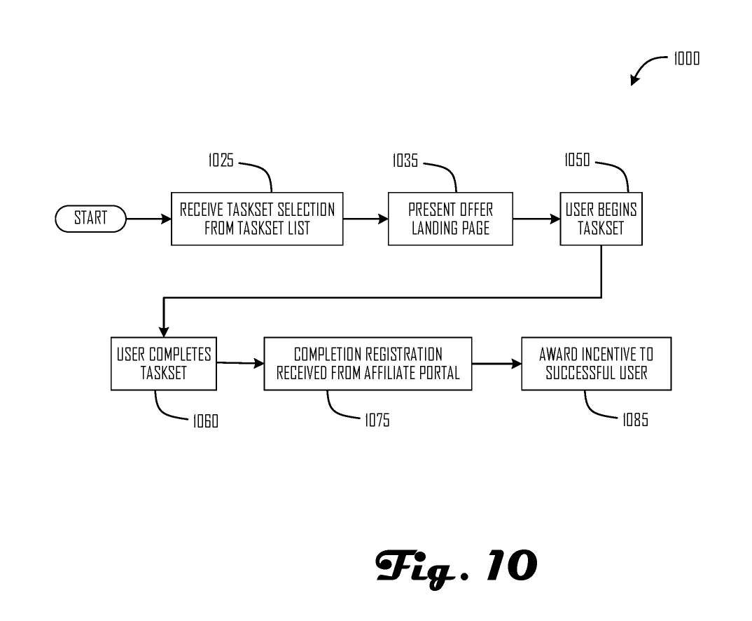

FIG. 10 depicts an incentive earning flow 1000 performed primarily by one or more processing units 202, 302 in response to actions of client device users. At operation 1025 a taskset selection (manifested as a taskset identifier 641, e.g.) is received from a client device 200 that has displayed a taskset list 600 (via which party 20 signaled the taskset selection, e.g.). In response at operation 1035, an offer landing page is displayed via the client device 200, signaling a commencement of the user's performance of the selected taskset at operation 1050. Upon completion or in completion of the taskset at operation 1060, a proof of completion (corroboration, e.g.) is received such as by a completion registration being received from an affiliate portal at operation 1075.

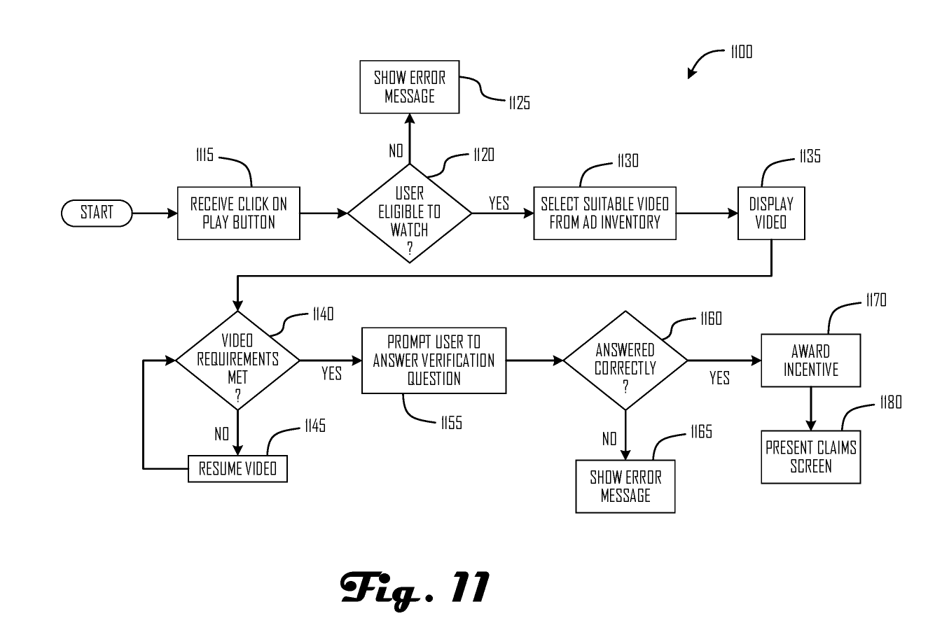

FIG. 11 depicts another incentive earning flow 1100 performed primarily by one or more processing units 202, 302 in response to actions of client device users. At operation 1115 an activation of a user control or other triggering event (a click on a play button, e.g.) is detected. If at operation 1120 a user (party 20, e.g.) is deemed ineligible to receive compensation for a taskset that includes watching an advertisement (based on user age or a history of prior online actions, e.g.), an error message is shown 1125 and flow 1100 concludes. Otherwise at operation 1130 a suitable video is selected (from an ad inventory, e.g.) and at operation 1135 it is displayed.

If at operation 1140 one or more video requirements (watching enough of the video as defined by a sponsoring entity 110A, e.g.) are not met then the video is resumed at operation 1145 until the one or more requirements are met (or an abort event is detected).

If the one or more requirements are met at operation 1140, the user is prompted to answer one or more verification questions at operation 1155. If an insufficient number or fraction of answers are deemed incorrect at operation 1160, an error message is shown at operation 1165 and flow 1100 concludes. Otherwise at operation 1170 the incentive 645 is awarded and at operation 1180 a claims screen is presented (confirming the award and presenting, if appropriate, any dispensation eligibilities or just-unlocked tasksets, e.g.).

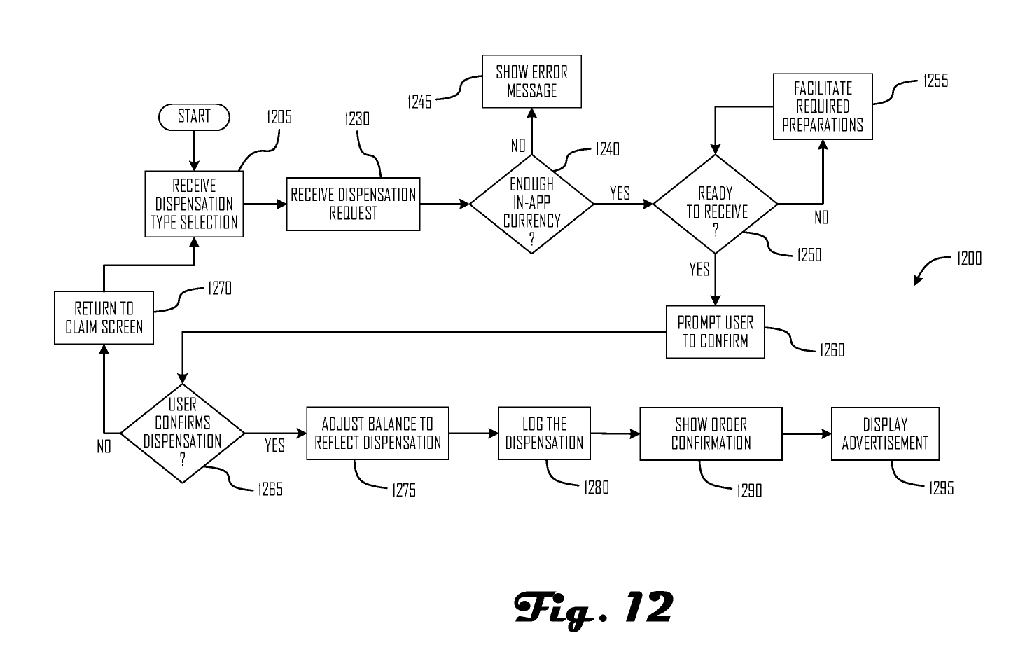

FIG. 12 depicts a dispensation flow 1200 performed primarily by one or more processing units 202, 302 in response to actions of client device users. At operation 1205 a dispensation type selection is received. For example such selection can include (as a component of participant sign up process flow 900, e.g.) a designation of one or more user-preferred physical goods, one or more online resources (cryptocurrencies, e.g.), prize valuation parameters (a minimum and maximum signaling a range of suitable valuations, e.g.), or combinations of such parameters upon which subsequent eligibility notifications 855 will be based.

A dispensation request for one or more selected prizes is received at operation 1230 and a determination is made at operation 1240 whether enough in-app currency is available to implement the dispensation. If not, at operation 1245 an error message is shown. Otherwise a determination is made at operation 1250 whether the recipient (party 20, e.g.) is ready to receive the dispensation (i.e. whether any required preparations are not yet complete). If not then at operation 1255 any incomplete tasks required for the dispensation are facilitated (by prompting for a registration of a digital wallet in preparation to receive an initial denomination of a cryptocurrency, e.g.) and operation 1250 is repeated.

Once a determination is made that required preparations are complete and the dispensation can occur, at operation 1260 the user is prompted to confirm the dispensation. If the confirmation is not provided, at operation 1270 control is returned to the claims screen (confirming an award of in-app currency or repeating operation 1205, e.g.). Otherwise the balance is adjusted at 1275 (adjusting a balance 734 of the client device 200, e.g.) to reflect the dispensation at operation 1275 and the dispensation is logged at operation 1280. Moreover where appropriate the order is confirmed at operation 1290 and a suitable advertisement is shown 1295 via the client device (promoting a next taskset of possible interest to the user, e.g.).

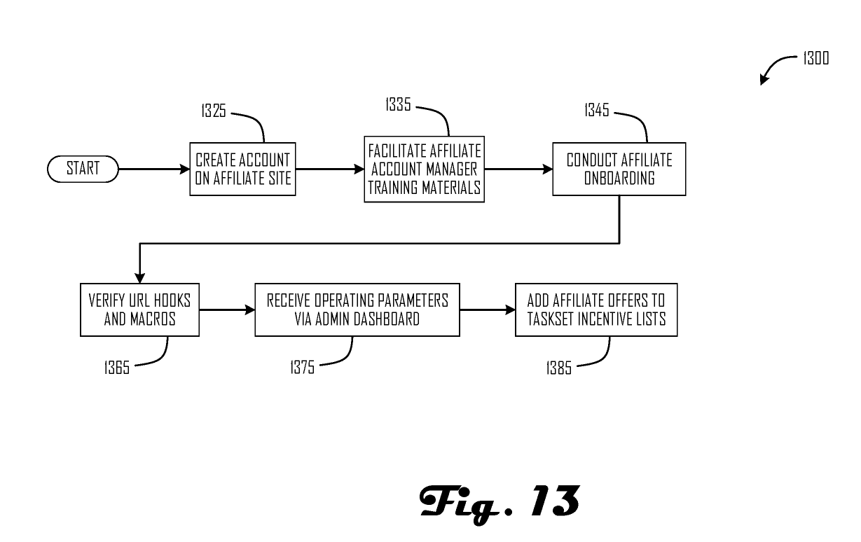

FIG. 13 depicts an affiliate enlistment flow 1300 performed primarily by one or more processing units 202, 302 in response to actions of client device users (affiliates 10, e.g.). At operation 1325 an account is created on an affiliate site. At operation 1335 affiliate account manager training materials are provided or otherwise facilitated. At operation 1345 affiliate onboarding is conducted. At operation 1365 one or more Universal Record Locator (URL) hoods and macros are verified. At operation 1375 one or more operating parameters (campaign valuations and taskset definitions, e.g.) are received. At operation 1385 affiliate offers (manifested as records 640, e.g.) are added to taskset incentive lists.

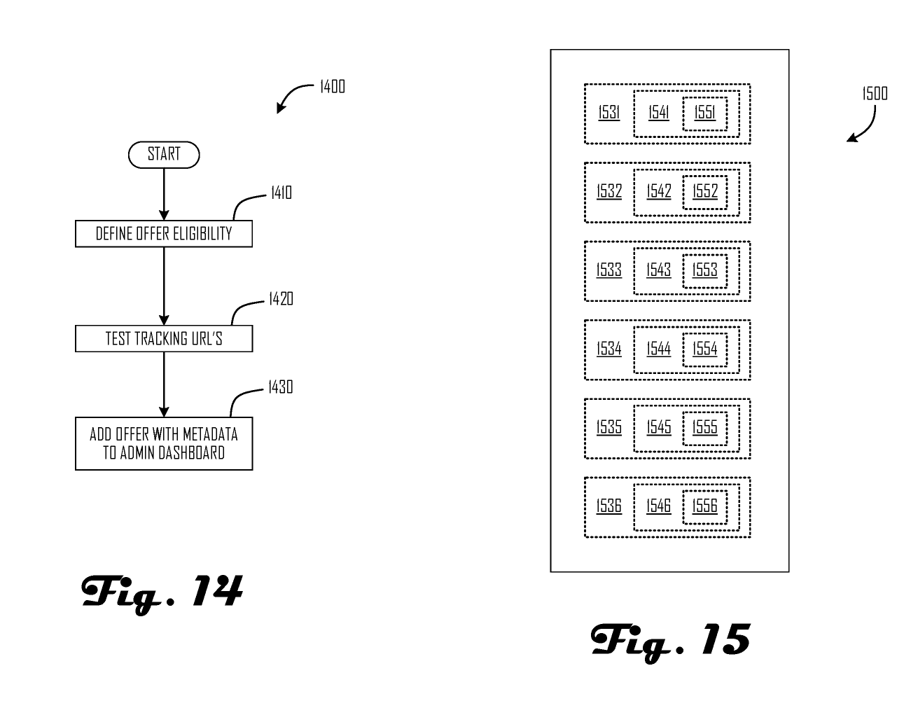

FIG. 14 depicts an offer addition flow 1400 performed primarily by one or more processing units 202, 302 in response to actions of client device users (affiliates 10 or other parties 20 who sponsor taskset completions, e.g.). At operation 1410 offer eligibilities (if any) are defined for each taskset 441. At operation 1420 tracking URL's are (configured and) tested. And at operation 1430 one or more offers with metadata (defining taskset parameters and relationships, e.g.) are added (via an admin dashboard, e.g.).

FIG. 15 depicts special-purpose transistor-based circuitry 1500—optionally implemented as an Application-Specific Integrated Circuit (ASIC) or in a UI governance server, e.g.—in which some or all of the functional modules described below may be implemented. Transistor-based circuitry 1500 is an event-sequencing structure generally as described in U.S. Pat. Pub. No. 20150094046 but configured as described herein. Transistor-based circuitry 1500 includes one or more instances of notification modules 1531, for example, each including an electrical node set 1541 upon which informational data is represented digitally as a corresponding voltage configuration 1551.

In the interest of concision and according to standard usage in information management technologies, the functional attributes of modules described herein are set forth in natural language expressions. It will be understood by those skilled in the art that such expressions (functions or acts recited in English, e.g.) adequately describe structures identified below so that no undue experimentation will be required for their implementation. For example, any records or other informational data identified herein may easily be represented digitally as a voltage configuration on one or more electrical nodes (conductive pads of an integrated circuit, e.g.) of an event-sequencing structure without any undue experimentation. Each electrical node is highly conductive, having a corresponding nominal voltage level that is spatially uniform generally throughout the node (within a device or local system as described herein, e.g.) at relevant times (at clock transitions, e.g.). Such nodes (lines on an integrated circuit or circuit board, e.g.) may each comprise a forked or other signal path adjacent one or more transistors. Moreover many Boolean values (yes-or-no decisions, e.g.) may each be manifested as either a “low” or “high” voltage, for example, according to a complementary metal-oxide-semiconductor (CMOS), emitter-coupled logic (ECL), or other common semiconductor configuration protocol. In some contexts, for example, one skilled in the art will recognize an “electrical node set” as used herein in reference to one or more electrically conductive nodes upon which a voltage configuration (of one voltage at each node, for example, with each voltage characterized as either high or low) manifests a yes/no decision or other digital data.

Transistor-based circuitry 1500 likewise includes one or more instances of detection modules 1532 each including an electrical node set 1542 upon which informational data is represented digitally as a corresponding voltage configuration 1552. Transistor-based circuitry 1500 likewise includes one or more instances of notification modules 1533 each including an electrical node set 1543 upon which informational data is represented digitally as a corresponding voltage configuration 1553. Transistor-based circuitry 1500 likewise includes one or more instances of notification modules 1534 each including an electrical node set 1544 upon which informational data is represented digitally as a corresponding voltage configuration 1554. Transistor-based circuitry 1500 likewise includes one or more instances of detection modules 1535 each including an electrical node set 1545 upon which informational data is represented digitally as a corresponding voltage configuration 1555. Transistor-based circuitry 1500 likewise includes one or more instances of dispensation modules 1536 each including an electrical node set 1546 upon which informational data is represented digitally as a corresponding voltage configuration 1556. In some variants, as described below in the clauses and claims, such a module implements such functionality jointly (in conjunction with other modules or processing units 302 described herein, e.g.). Alternatively or additionally, in some variants such modules (or components thereof) may be distributed (so that some are implemented in special-purpose circuitry 322 of respective servers 300, e.g.).

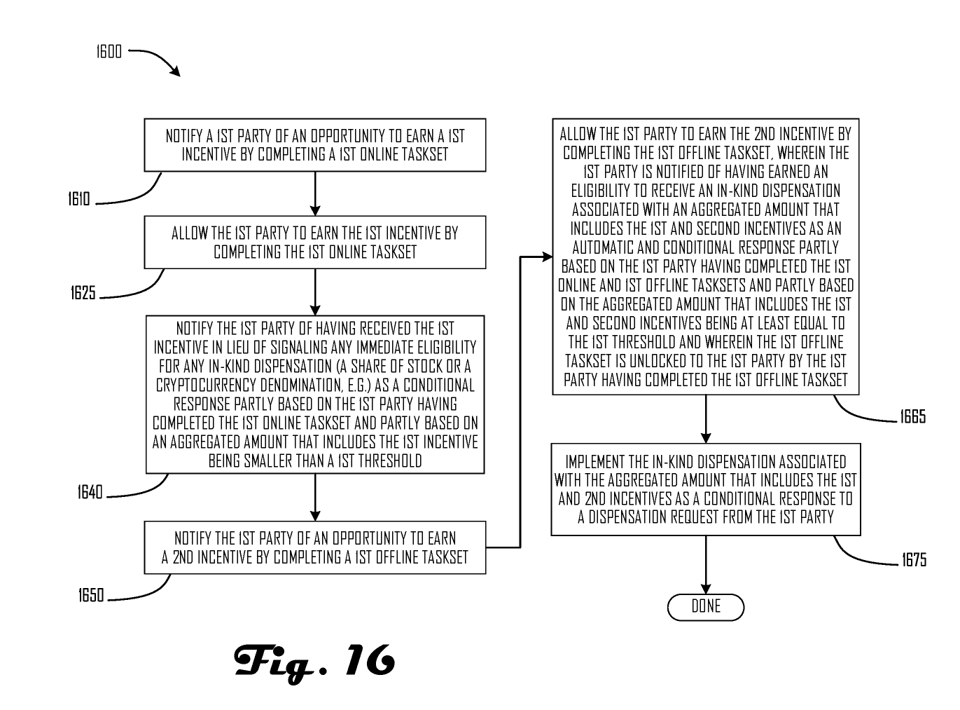

FIG. 1600 illustrates an operational flow 1600 (implemented in software as a routine executed or coordinated by one or more instances of processing unit 302, e.g.) suitable for use with at least one embodiment, such as may be performed (in some variants) on a server 300 using special-purpose circuitry 322 (via a process flow management service thereof, e.g.). As will be recognized by those having ordinary skill in the art, not all events of information management are illustrated in FIG. 16. Rather, for clarity, only those steps reasonably relevant to describing the tabular data modification aspects of flow 1600 are shown and described. Those having ordinary skill in the art will also recognize the present embodiment is merely one exemplary embodiment and that variations on the present embodiment may be made without departing from the scope of the broader inventive concept set forth in the clauses and claims below.

Operation 1610 describes notifying a first party of an opportunity to earn a first incentive by completing a first online taskset (a notification module 1531 transmitting a taskset broadcast 815 or otherwise inviting party 20B to earn an in-app currency or in-kind resource by completing a first online taskset 441, e.g.). This can occur, for example, in a context in which the online taskset includes viewing a tutorial video or passing a quiz (as shown in records 640B-C, e.g.), in which the invitation is expressed (in a broadcast message, e.g.) as a voltage configuration 1551 on an electrical node set 1541 of the notification module 1531, and in which the in-kind currency is identified by a goods identification parameter 411 or other resource identification parameter 410.

Operation 1625 describes allowing the first party to earn the first incentive by completing the first online taskset (a detection module 1532 responding to an online reporting of party 20B having completed the first online taskset 441, e.g.). This can occur, for example, in a context in which the detection module 1532 detects a successful completion of the taskset manifested by one or more correct answers being given (in a timed structured dialog question response implementing operation 1160, e.g.) by party 20B via client device 200Z and in which the successful completion is expressed as a Boolean-valued voltage configuration 1552 on an electrical node set 1542 of the detection module 1532. Alternatively or additionally, such completion may comprise being observed (via camera 791, e.g.) by entity 110A or corroborated via one or more other participant-provided client devices 200K as a component.

Operation 1640 describes notifying the first party of having received the first incentive in lieu of signaling any immediate eligibility for any in-kind dispensation as a conditional response partly based on the first party having completed the first online taskset and partly based on an aggregated amount that includes the first incentive being smaller than a first threshold (a notification module 1533 informing party 20B of his account 733A having received 50 units of in-app currency without indicating any non-cash mode of dispensation having become available, e.g.). This can occur, for example, in a context in which the first incentive is merely incremental (insufficient to bring balance 734A above a dispensation threshold 471, e.g.); in which notification module 1533 is configured not to provide such notification except as a conditional, contemporaneous response to balance 734A becoming large enough to allow a dispensation consistent with one or more preferred types of incentive previously designated as “preferred” by party 20B, e.g.); in which the first incentive of (the present instance of) operation 1640 does not trigger any new dispensation eligibilities (of which party 20B has yet to be notified, e.g.), and in which the comparison result of “being smaller” is expressed as a voltage configuration 1553 on an electrical node set 1543 of the notification module 1533.

Operation 1650 describes notifying the first party of an opportunity to earn a second incentive by completing a first offline taskset (a notification module 1534 inviting party 20B to take advantage of a now-unlocked opportunity to earn an additional amount of in-app currency by completing a now-unlocked offline taskset 441, e.g.). This can occur, for example, in a context in which the now-unlocked offline taskset includes a taskset with a description 642 of “PROVIDE A VEHICLE EVALUATION,” in which the invitation is expressed as a voltage configuration 1554 on an electrical node set 1544 of the notification module 1534, in which the first offline taskset builds upon the first online taskset as a succession of waypoints (an instance of sequence 442 such that one of the prerequisite tasksets 441A precedes at least one of the now-unlocked offline tasksets 441B and directly or otherwise causes the latter to become unlocked, e.g.), and in which appropriately skilled parties could not otherwise be found promptly (when needed) within a remote region 705. In some variants, for example, a record 640D that defines the first offline taskset specifies one or more prerequisite tasksets 647 that include the “first” online taskset. In some such contexts, operation 1650 can allow qualified contractors (reliably impartial expert service providers, e.g.) in a region 705 to be recruited or developed from afar (by an overseas party 20 wanting to buy a reliable vehicle 795 “sight unseen” on behalf of a party 20C who is his sister, e.g.) while incurring near-zero transportation and training costs.

Operation 1660 describes allowing the first party to earn the second incentive by completing the first offline taskset (a detection module 1535 determining that party 20B is eligible for and has earned the second incentive and thereby become eligible to receive an in-kind dispensation 470 that he wanted, e.g.). This can occur, for example, in a context in which party 20B has previously identified a class of dispensations that include the in-kind dispensation 470; in which the in-kind dispensation 470 is now affordable (at least partly) because the first and second incentives 645 are together at least equal to the first threshold 471 (as well as any in-app currency transaction costs incurred by the dispensation); in which notification module 1534 has notified party 20B as a conditional response to the eligibility for the in-kind dispensation 470; and in which the comparison result is expressed as a voltage configuration 1555 on an electrical node set 1545 of the notification module 1535.

Operation 1675 describes implementing the in-kind dispensation associated with the aggregated amount that includes the first and second incentives as a conditional response to a dispensation request from the first party (a dispensation module 1536 triggering the in-kind dispensation associated with the aggregated amount that includes at least the first and second incentives as a conditional response to a dispensation request from party 20B, e.g.). This can occur, for example, in a context in which a final authorization is solicited and received from party 20B shortly before the in-kind dispensation; in which current cost or availability of the item(s) to be dispensed is thereafter confirmed; and in which a mode of compensation that specifies a form or destination of dispensation is expressed as a voltage configuration 1556 on an electrical node set 1546 of the dispensation module 1536. In some contexts, for example, dispensation module 1536 may perform operation 1675 by dispensing one or more tickets 794 (for admission or redemption as a component of the in-kind dispensation, e.g.) to party 20B via client device 200Z.

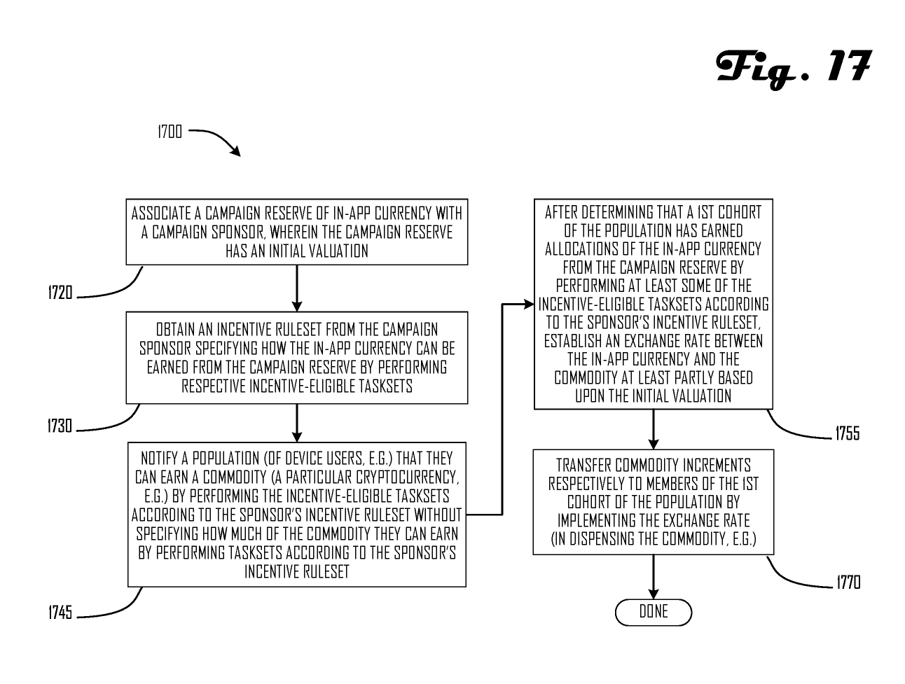

FIG. 17 illustrates an operational flow 1700 in which one or more technologies may be implemented (within or in conjunction with special-purpose circuitry 322, e.g.). Operation 1720 describes associating a campaign reserve 461 of in-app currency with a campaign sponsor (entity 110A, e.g.), wherein the campaign reserve has an initial valuation 462. Operation 1730 describes obtaining an incentive ruleset 440 from the campaign sponsor specifying how the in-app currency can be earned from the campaign reserve by performing one or more incentive-eligible tasksets 441 (according to a timeline 445 and other required terms 447, e.g.).

Operation 1745 describes notifying a population (of members or other participants, e.g.) that they can earn a resource (identifying a target cryptocurrency, e.g.) by performing the incentive-eligible tasksets 441 according to the sponsor's incentive ruleset 440 without promising them how much of the commodity they can earn by performing tasksets according to the sponsor's incentive ruleset. Operation 1755 describes establishing one or more payout or exchange rates 472 (between the in-app currency and the commodity, e.g.) at least partly based upon the initial valuation 462 after one or more participants of the population have earned respective allocations of the in-app currency from the campaign reserve by performing at least some of the incentive-eligible tasksets 441 according to the sponsor's incentive ruleset 440.

Operation 1770 describes transferring commodity dispensations respectively to members of the population by implementing the first exchange rate from the in-app currency to the commodity (in response to a request or other authorization, e.g.). This may occur, for example, in a context in which some or all features set forth in an appendix below are implemented and in which no systematic payout in a particular target commodity would otherwise be feasible (because of the small values earned in each of the tasksets 441A-B, e.g.).

In some variants of the foregoing, as further described below, a task-category-specific reputation level or other qualification may control which participants/users are notified of or otherwise eligible to perform tasksets. Alternatively or additionally, such task-category-specific qualifications (skills, e.g.) may improve as an automatic and conditional response to a successful completion of tasksets (of education or training certification, e.g.). In some variants, for example, a taskset thereby unlocked may include one or more freelance product development tasks (crowdsourced QA testing or machine learning facilitation, e.g.) performed via one or more mobile devices 200B-Y.

Likewise in some variants of the foregoing, as further described below, a task-category-specific qualification of a user may reflect a (predicted or actual) user-specific purchase volume in a product or service category (sportswear, e.g.) related to an advertisement. This can occur, for example, in a context in which the tasksets 441 include allowing the advertisement to be presented via the mobile device 200B or otherwise opting in to the advertisement and in which the advertisement would not otherwise be effective.

In some variants of the foregoing, as further described below, a task-category-specific reputation level or other qualification may control which parties/users are notified of or otherwise eligible to perform tasksets. Alternatively or additionally, such task-category-specific qualifications (skills, e.g.) may improve as an automatic and conditional response to a successful completion of tasksets (of education or training certification, e.g.). In some variants, for example, a taskset thereby unlocked may include one or more freelance product development tasks (crowdsourced QA testing or machine learning facilitation, e.g.) performed via one or more mobile devices 200B-Y.

Likewise in some variants of the foregoing, as further described below, a task-category-specific qualification of a user may reflect a (predicted or actual) user-specific purchase volume in a product or service category (sportswear, e.g.) related to an advertisement. This can occur, for example, in a context in which the tasksets 441 include allowing the advertisement to be presented via the mobile device 200B or otherwise opting in to the advertisement and in which the advertisement would not otherwise be effective.

Referring again to FIG. 15, in some variants a notification module 1531 may be configured to notify a first party of an opportunity to earn a first incentive by completing a first taskset (offering party 20A a bounty of in-app currency for listing his vehicle 795 online). In some variants notification module 1533 can likewise be configured to notify the first party of having received that bounty even without any immediately apparent way to spend it. If such an action unlocks another opportunity to earn an additional amount of in-app currency (by recruiting and engaging a qualified third party 20B to assure potential buyers that the vehicle 795 is reliable, e.g.), however, in some variants notification module 1534 can likewise be inform him as such. In some contexts, moreover, a taskset that includes actually transferring title to the vehicle 795 may encompass the value of the vehicle, so that the vehicle is effectively bartered or purchased with in-app currency and so that no actual currency is necessarily associated with the transfer.

In light of teachings herein, numerous existing techniques may be applied for configuring special-purpose circuitry or other structures effective for configuring, broadcasting, and otherwise managing incentives, dispensations, and other tasks as described herein without undue experimentation. See, e.g., U.S. Pat. No. 9,747,586 (“System and method for issuance of electronic currency substantiated by a reserve of assets”); U.S. Pat. No. 9,737,813 (“Cognitive training method for semantic skills enhancement”); U.S. Pat. No. 9,672,499 (“Data analytic and security mechanism for implementing a hot wallet service”); U.S. Pat. No. 9,646,029 (“Methods and apparatus for a distributed database within a network”); U.S. Pat. No. 9,595,034 (“System and method for monitoring third party access to a restricted item”); U.S. Pat. No. 9,576,313 (“Recommendation systems and methods using interest correlation”); U.S. Pat. No. 9,569,771 (“Method and system for storage and retrieval of blockchain blocks using Galois fields”); U.S. Pat. No. 9,569,439 (“Context-sensitive query enrichment”); U.S. Pub. No. 20170243239 (“Incentivized navigation”); U.S. Pub. No. 20170132199 (“Unconventional virtual assistant interactions”); U.S. Pub. No. 20160260095 (“Containerized Computational Task Execution Management Using a Secure Distributed Transaction Ledger”); U.S. Pat. Pub. No. 20140214845 (“Product classification into product type families”); U.S. Pub. No. 20140200980 (“System and method for mediating transactions among a plurality of social commerce businesses”); U.S. Pat. Pub. No. 20140172767 (“Budget optimal crowdsourcing”); U.S. Pub. No. 20130346254 (“Project intermediary device and project intermediary method”); U.S. Pub. No. 20130061288 (“Method for controlling trust and confidentiality in daily transactions of the digital environment”); U.S. Pub. No. 20120095908 (“Distributed Computing for Engaging Software Services”); U.S. Pub. No. 20120020476 (“Method for Performing a Cryptographic Task in an Electronic Hardware Component”); U.S. Pat. Pub. No. 20110313933 (“Decision-theoretic control of crowd-sourced workflows”); and U.S. Pub. No. 20100332336 (“System and method for electronic wallet conversion”). Although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

All of the patents and other publications referred to above are incorporated herein by reference generally—including those identified in relation to particular new applications of existing techniques—to the extent not inconsistent herewith. While various system, method, article of manufacture, or other embodiments or aspects have been disclosed above, also, other combinations of embodiments or aspects will be apparent to those skilled in the art in view of the above disclosure. The various embodiments and aspects disclosed above are for purposes of illustration and are not intended to be limiting, with the true scope and spirit being indicated in the final claim set that follows.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

### CLAUSES

1. An incentivization system comprising:

transistor-based circuitry (one or more notification modules 1531, e.g.) configured to notify a first party 20 of an opportunity to earn a first incentive by completing a first taskset 441A;

transistor-based circuitry (one or more detection modules 1532, e.g.) configured to allow the first party 20 to earn the first incentive by completing the first taskset 441A;

transistor-based circuitry (one or more notification modules 1533, e.g.) configured to notify the first party 20 of having received the first incentive in lieu of signaling any immediate eligibility for any in-kind dispensation (a share of stock or a cryptocurrency denomination, e.g.) as a conditional response partly based on the first party 20 having completed the first taskset 441A and partly based on an aggregated amount that includes the first incentive being smaller than a first threshold 471;

transistor-based circuitry (one or more notification modules 1534, e.g.) configured to notify the first party 20 of an opportunity to earn a second incentive by completing a second taskset 441B;

transistor-based circuitry (one or more detection modules 1535, e.g.) configured to allow the first party 20 to earn the second incentive by completing the second taskset 441B, wherein the first party 20 is notified of having earned an eligibility to receive an in-kind dispensation associated with an aggregated amount that includes the first and second incentives as an automatic and conditional response partly based on the first party 20 having completed the first and second taskset 441 and partly based on the aggregated amount that includes the first and second incentives being at least equal to the first threshold 471 and wherein the second taskset 441B is unlocked to the first party 20 by the first party 20 having completed the second taskset 441B; and

transistor-based circuitry (one or more dispensation modules 1536 in conjunction with a dispenser 793, e.g.) configured to implement the in-kind dispensation associated with the aggregated amount that includes the first and second incentives as a conditional response to a dispensation request from the first party 20.

2. The system of System Clause 1, wherein the transistor-based circuitry (one or more dispensation modules 1536 in conjunction with dispenser 793, e.g.) configured to implement the in-kind dispensation associated with the aggregated amount that includes the first and second incentives as a conditional response to a dispensation request from the first party 20 comprises:

one or more dispensation modules 1536 in conjunction with a dispenser 793, wherein the dispenser is configured to expel the in-kind dispensation as a physical article (a ticket, e.g.).

3. The system of System Clause 1, wherein the transistor-based circuitry (one or more dispensation modules 1536 in conjunction with dispenser 793, e.g.) configured to implement the in-kind dispensation associated with the aggregated amount that includes the first and second incentives as a conditional response to a dispensation request from the first party 20 comprises:

one or more dispensation modules 1536 in conjunction with a dispenser 793.

4. The system of System Clause 1, wherein all of the transistor-based circuitry is implemented on a single application-specific integrated circuit (ASIC).

5. The system of System Clause 1, wherein the transistor-based circuitry is distributed across two or more mutually remote facilities.

6. An incentivization method comprising:

invoking transistor-based circuitry (one or more notification modules 1531, e.g.) configured to notify a first party 20 of an opportunity to earn a first incentive by completing a first taskset 441A;

invoking transistor-based circuitry (one or more detection modules 1532, e.g.) configured to allow the first party 20 to earn the first incentive by completing the first taskset 441A;

invoking transistor-based circuitry (one or more notification modules 1533, e.g.) configured to notify the first party 20 of having received the first incentive in lieu of signaling any immediate eligibility for any in-kind dispensation (a share of stock or a cryptocurrency denomination, e.g.) as a conditional response partly based on the first party 20 having completed the first taskset 441A and partly based on an aggregated amount that includes the first incentive being smaller than a first threshold 471;

invoking transistor-based circuitry (one or more notification modules 1534, e.g.) configured to notify the first party 20 of an opportunity to earn a second incentive by completing a second taskset 441B;

invoking transistor-based circuitry (one or more detection modules 1535, e.g.) configured to allow the first party 20 to earn the second incentive by completing the second taskset 441B, wherein the first party 20 is notified of having earned an eligibility to receive an in-kind dispensation associated with an aggregated amount that includes the first and second incentives as an automatic and conditional response partly based on the first party 20 having completed the first and second tasksets 441 and partly based on the aggregated amount that includes the first and second incentives being at least equal to the first threshold 471, and wherein the second taskset 441B is unlocked to the first party 20 by the first party 20 having completed the second taskset 441B; and

implementing the in-kind dispensation associated with the aggregated amount that includes the first and second incentives as a conditional response to a dispensation request from the first party 20.

7. The method of ANY of the above method clauses, wherein the invoking transistor-based circuitry configured to allow the first party 20 to earn the second incentive by completing the second taskset 441B comprises:

notifying the first party 20 of having earned the eligibility to receive the in-kind dispensation associated with the aggregated amount that includes the first and second incentives as the automatic and conditional response partly based on the first party 20 having completed the first and second tasksets 441 and partly based on the aggregated amount that includes the first and second incentives being at least equal to the first threshold 471; and

receiving proof of completion of the second taskset, wherein the proof of completion includes (at least) a completion registration (a message 735 confirming the completion received from an affiliate portal or other instrumentality of a third party entity 110A, e.g.).

8. The method of ANY of the above method clauses, wherein the first threshold 471 is (at least partly) based on one or more resource type identifiers selected by the first party.

9. The method of ANY of the above method clauses, wherein the first taskset 441A comprises watching an online video.

10. The method of ANY of the above method clauses, wherein the second taskset 441B essentially consists of delivering material (supplies 591, e.g.).

11. The method of ANY of the above method clauses, wherein the second taskset 441B comprises a component of a healthcare regimen (taking medications provided via a portable dispenser 581, e.g.).

12. The method of ANY of the above method clauses, wherein the second taskset 441B comprises establishing one or more credentials of the first party 20 (earning a license 571 or certification 572, e.g.).

13. The method of ANY of the above method clauses, wherein the first taskset 441A comprises the first party answering one or more online questions correctly (demonstrating the existence of a state-issued license 571 or demonstrating a proficiency 575 by taking an online quiz, e.g.).

14. The method of ANY of the above method clauses, wherein at least one of the first or second taskset 441A-B comprises establishing one or more credentials of the first party 20 (earning a state-issued license 571, demonstrating the existence of a state-issued license 571, or demonstrating a proficiency 575 by taking an online quiz, e.g.).

15. The method of ANY of the above method clauses, wherein the implementing the in-kind dispensation associated with the aggregated amount that includes the first and second incentives as the conditional response to the dispensation request from the first party comprises:

implementing the in-kind dispensation in an automated batch process simultaneously delivering the in-kind dispensation to numerous recipients (i.e. dozens, e.g.), wherein the first party is one of the numerous recipients.

16. The method of ANY of the above method clauses, wherein the implementing the in-kind dispensation associated with the aggregated amount that includes the first and second incentives as the conditional response to the dispensation request from the first party comprises:

implementing the in-kind dispensation in a broadcast of an online resource.

17. The method of ANY of the above method clauses, wherein the first party 20 receives only a single unit of a cryptocurrency (one Bitcoin, e.g.) in the in-kind dispensation.

18. The method of ANY of the above method clauses, further comprising:

implementing a participant sign up process flow as depicted in FIG. 9.

19. The method of ANY of the above method clauses, further comprising:

implementing an incentive earning flow as depicted in FIG. 10.

20. The method of ANY of the above method clauses, further comprising:

implementing an incentive earning flow as depicted in FIG. 11.

21. The method of ANY of the above method clauses, further comprising:

implementing a dispensation flow as depicted in FIG. 12.

22. The method of ANY of the above method clauses, further comprising:

implementing an affiliate enlistment flow as depicted in FIG. 13.

23. The method of ANY of the above method clauses, further comprising:

implementing an offer addition flow as depicted in FIG. 14.

24. The method of ANY of the above method clauses, further comprising:

mitigating cryptocurrency volatility as depicted in FIG. 17.

With respect to the numbered claims expressed below, those skilled in the art will appreciate that recited operations therein may generally be performed in any order. Also, although various operational flows are presented in sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1. An incentivization method comprising:
invoking transistor-based circuitry configured to notify a first party of an opportunity to earn a first incentive by completing a first online taskset;
invoking transistor-based circuitry configured to allow said first party to earn said first incentive by completing said first online taskset;
invoking transistor-based circuitry configured to notify said first party of having received said first incentive in lieu of signaling any immediate eligibility for any in-kind dispensation as a conditional response partly based on said first party having completed said first online taskset and partly based on an aggregated amount that includes said first incentive being smaller than a first threshold;
invoking transistor-based circuitry to notify said first party of an opportunity to earn a second incentive by completing a first offline taskset;
invoking transistor-based circuitry configured to allow said first party to earn said second incentive by completing said first offline taskset, wherein said first party is notified of having earned an eligibility to participate in an in-kind dispensation associated with an aggregated amount that includes said first and second incentives as an automatic and conditional response partly based on said first party having completed said first online and first offline tasksets and partly based on said aggregated amount that includes said first and second incentives being at least equal to said first threshold, wherein said first offline taskset is unlocked to said first party by said first party having completed said first online taskset, wherein said first online taskset comprises viewing training materials online, wherein said first offline taskset comprises one or more product development tasks related to said training materials, and wherein said first threshold is based on one or more resource type identifiers selected by said first party; and
implementing said in-kind dispensation associated with said aggregated amount that includes said first and second incentives as a conditional response to a dispensation request from said first party, wherein said implementing said in-kind dispensation associated with said aggregated amount that includes said first and second incentives as said conditional response to said dispensation request from said first party comprises:
implementing said in-kind dispensation in an automated batch process simultaneously to numerous recipients, wherein said first party is one of said numerous recipients, wherein said numerous recipients include said first party and a second party, wherein a first client device is used by said first party, wherein a second client device is used by said second party, wherein said first and second client devices both participate in said in-kind dispensation, and wherein said second device is a blockchain node.

2. The method of claim 1, wherein said first online taskset comprises said first party answering one or more online questions correctly and wherein said invoking transistor-based circuitry to notify said first party of said opportunity to earn said second incentive by completing said first offline taskset comprises:
confirming said correctness of one or more answers to said one or more online questions.

3. The method of claim 1, wherein said in-kind dispensation transfers a single unit of a cryptocurrency to said first party.

4. An incentivization method comprising:
invoking transistor-based circuitry configured to notify a first party of an opportunity to earn a first incentive by completing a first online taskset;
invoking transistor-based circuitry configured to allow said first party to earn said first incentive by completing said first online taskset;
invoking transistor-based circuitry configured to notify said first party of having received said first incentive in lieu of signaling any immediate eligibility for any in-kind dispensation as a conditional response partly based on said first party having completed said first online taskset and partly based on an aggregated amount that includes said first incentive being smaller than a first threshold;
invoking transistor-based circuitry to notify said first party of an opportunity to earn a second incentive by completing a first offline taskset;
invoking transistor-based circuitry configured to allow said first party to earn said second incentive by completing said first offline taskset, wherein said first party is notified of having earned an eligibility to participate in an in-kind dispensation associated with an aggregated amount that includes said first and second incentives as an automatic and conditional response partly based on said first party having completed said first online and first offline tasksets and partly based on said aggregated amount that includes said first and second incentives being at least equal to said first threshold wherein said first online taskset includes viewing training materials online, wherein first offline taskset comprises one or more tasks that require a skill related to said training materials, and wherein said first offline taskset is unlocked to said first party by said first party having completed said first online taskset that includes viewing said training materials online; and
implementing said in-kind dispensation associated with said aggregated amount that includes said first and second incentives as a conditional response to a dispensation request from said first party, wherein a first client device is used by said first party, wherein a second client device is used by a second party, wherein said first and second client devices both participate in said in-kind dispensation, and wherein said second device is a blockchain node.

5. The method of claim 4, wherein said first threshold is based on one or more resource type identifiers selected by said first party.

6. The method of claim 4, wherein said first online taskset comprises watching an online video.

7. The method of claim 4, wherein said first offline taskset comprises a component of a healthcare regimen.

8. The method of claim 4, wherein said first online taskset comprises establishing one or more credentials of said first party.

9. The method of claim 4, wherein said first online taskset comprises said first party answering one or more online questions correctly.

10. The method of claim 4, wherein said implementing said in-kind dispensation associated with said aggregated amount that includes said first and second incentives as said conditional response to said dispensation request from said first party comprises:
implementing said in-kind dispensation in an automated batch process simultaneously to numerous recipients, wherein said first and second parties are among said numerous recipients.

11. The method of claim 4, wherein said implementing said in-kind dispensation associated with said aggregated amount that includes said first and second incentives as said conditional response to said dispensation request from said first party comprises:
implementing said in-kind dispensation in a broadcast of an online resource.

12. The method of claim 4, wherein said in-kind dispensation transfers a single unit of a cryptocurrency to said first party.

13. The method of claim 4, wherein the invoking transistor-based circuitry configured to allow the first party to earn the second incentive by completing the first offline taskset comprises:
notifying the first party of having earned the eligibility to participate in the in-kind dispensation associated with the aggregated amount that includes the first and second incentives as the automatic and conditional response partly based on the first party having completed the first and second taskset and partly based on the aggregated amount that includes the first and second incentives being at least equal to the first threshold; and
receiving proof of completion of the second taskset, wherein the proof of completion includes a completion registration.

14. An incentivization system comprising:
transistor-based circuitry configured to notify a first party of an opportunity to earn a first incentive by completing a first online taskset;
transistor-based circuitry configured to allow said first party to earn said first incentive by completing said first online taskset;
transistor-based circuitry configured to notify said first party of having received said first incentive in lieu of signaling any immediate eligibility for any in-kind dispensation as a conditional response partly based on said first party having completed said first online taskset and partly based on an aggregated amount that includes said first incentive being smaller than a first threshold;
transistor-based circuitry configured to notify said first party of an opportunity to earn a second incentive by completing a first offline taskset;
transistor-based circuitry configured to allow said first party to earn said second incentive by completing said first offline taskset, wherein said first party is notified of having earned an eligibility to participate in an in-kind dispensation associated with an aggregated amount that includes said first and second incentives as an automatic and conditional response partly based on said first party having completed said first online and first offline tasksets and partly based on said aggregated amount that includes said first and second incentives being at least equal to said first threshold, wherein said first online taskset comprises viewing training materials online, wherein first offline taskset comprises one or more tasks that require a skill related to said training materials, and wherein said first offline taskset is unlocked to said first party by said first party having completed said first online taskset; and
transistor-based circuitry configured to implement said in-kind dispensation associated with said aggregated amount that includes said first and second incentives as a conditional response to a dispensation request from said first party, wherein a first client device is used by said first party, wherein a second client device is used by a second party, wherein said first and second client devices both participate in said in-kind dispensation, and wherein said second device is a blockchain node.

15. The system of claim 14, wherein all of said transistor-based circuitry is located at a single kiosk, wherein said transistor-based circuitry configured to implement said in-kind dispensation associated with said aggregated amount that includes said first and second incentives as said conditional response to said dispensation request from said first party comprises a dispenser of said kiosk, and wherein said dispenser is configured to expel said in-kind dispensation as a physical article.

16. The system of claim 14, wherein said transistor-based circuitry configured to notify said first party of having received said first incentive in lieu of signaling any immediate eligibility for any in-kind dispensation as said conditional response partly based on said first party having completed said first online taskset and partly based on said aggregated amount that includes said first incentive being smaller than said first threshold is configured to perform a method that comprises:
receiving a definition of one or more video requirements, wherein the definition determines a threshold of said one or more video requirements;
allowing a presentation of said training materials to be interrupted before said threshold of said one or more video requirements is reached;
allowing said presentation of said training materials to resume and to proceed until said threshold of said one or more video requirements is reached; and
authorizing an award of said first incentive to said first party in response to said first party completing said first online taskset, wherein completing said first online taskset is established by said threshold of said one or more video requirements being reached.

17. The method of claim 4, wherein said invoking said transistor-based circuitry configured to notify said first party of having received said first incentive in lieu of signaling any immediate eligibility for any in-kind dispensation as said conditional response partly based on said first party having completed said first online taskset and partly based on said aggregated amount that includes said first incentive being smaller than said first threshold comprises:
receiving a definition of one or more video requirements, wherein the definition determines a threshold of said one or more video requirements;
allowing a presentation of said training materials to be interrupted before said threshold of said one or more video requirements is reached;
allowing said presentation of said training materials to resume and to proceed until said threshold of said one or more video requirements is reached; and
awarding said first incentive to said first party in response to said first party completing said first online taskset, wherein completing said first online taskset is established by said threshold of said one or more video requirements being reached.

18. The method of claim 1, wherein said one or more product development tasks related to the training materials of the first offline taskset include a quality assurance test and wherein said first party is allowed to earn said second incentive only by completing said quality assurance test.
